(19) United States
(12) Patent Application Publication
(10) Pub. No.: US 2005/0249339 A1
(43) Pub. Date: Nov. 10, 2005

(54) Providing notification of voicemail (VM) messages using instant messaging (IM) transport

(76) Inventors: Mary S. Arnoff, Lawrenceville, GA (US); Larry G. Kent JR., Loganville, GA (US); W. Todd Daniell, Marietta, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 10/839,535

(22) Filed: May 5, 2004

(51) Int. Cl. H04M 1/64; H02P 7/00

(52) U.S. Cl. 379/88.17; 379/88.22

(57) ABSTRACT

Systems and methods are disclosed in which notifications of incoming voicemail (VM) messages are provided over an instant messaging (IM) transport. Briefly described, for some embodiments, among others, notifications for VM messages are generated, and the generated notifications are then transmitted to an IM contact address over an IM transport.

### FIELD OF THE INVENTION

The present disclosure relates generally to digital communications and, more particularly, to digital notification systems and methods.

### BACKGROUND

Communications systems are becoming increasingly sophisticated with the development of Internet-based communication modalities. The Internet-based communication modalities include email and instant messaging (IM), among others. While advances have been made in consolidating different communications services, there is an ongoing need for further consolidation.

### SUMMARY

The present disclosure provides systems and methods for providing notifications for incoming voicemail (VM) messages over an instant messaging (IM) transport. Briefly described, for some embodiments, among others, notifications for VM messages are generated, and the generated notifications are then transmitted to an IM contact address over an IM transport.

Other systems, devices, methods, features, and advantages will be or become apparent to one with skill in the art upon examination of the following drawings and detailed description. It is intended that all such additional systems, methods, features, and advantages be included within this description, and be within the scope of the present disclosure.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram showing an embodiment of a network having a digital voicemail (VM) repository and an instant messaging (IM) transport.

FIG. 2 is a block diagram showing, in greater detail, the IM client software of FIG. 1.

FIG. 3 is a block diagram showing, in greater detail, the VM agent software of FIG. 1.

FIG. 4 is a data-flow diagram showing an embodiment of a process for storing digital voicemail messages within the environment of FIG. 1.

FIG. 5A is a data-flow diagram showing an embodiment of a process for generating a notification of a received digital VM message.

FIG. 5B is a data-flow diagram showing another embodiment of a process for generating a notification of a received digital VM message.

FIG. 6 is a data-flow diagram showing an embodiment of a process for conveying the notification to an IM subscriber through the IM transport.

FIG. 7 is a flowchart showing an embodiment of a method for generating a notification of a received digital VM message.

FIG. 8 is a flowchart showing another embodiment of a method for generating a notification of a received digital VM message.

### DETAILED DESCRIPTION OF THE EMBODIMENTS

Reference is now made in detail to the description of the embodiments as illustrated in the drawings. While several embodiments are described in connection with these drawings, there is no intent to limit the invention to the embodiment or embodiments disclosed herein. On the contrary, the intent is to cover all alternatives, modifications, and equivalents.

Communications systems are becoming increasingly sophisticated with the development of Internet-based communication modalities. Of particular relevance, instant messaging (IM) has become a popular medium due to its near real-time conveyance of messages. While the IM transport is mostly used for near real-time IM chat sessions, these IM chat sessions are only one aspect of IM communications.

The present disclosure provides systems and methods for providing notifications for incoming voicemail (VM) messages over IM transport. In some embodiments, among others, the operating environment involves a subscriber that has both a digital VM mailbox and an IM account. In that operating environment, a VM agent mediates communications between a digital VM repository and the subscriber's IM client. The VM agent detects incoming VM messages to the subscriber's VM mailbox. When the subscriber receives a digital VM message, a notification for that VM message is generated. In some embodiments, the VM message notification is generated by the VM mailbox and conveyed to the VM agent. In other embodiments, the VM agent polls the VM mailbox and generates a VM message notification when a VM message is deposited to the VM mailbox.

The VM message notification is transmitted from the VM agent to an IM subscriber over an IM transport. So long as the IM subscriber is present online through an IM client, the IM subscriber, who is also the subscriber of the VM mailbox, receives the VM message notification in near-real-time via the subscriber's IM client. The various drawings show several embodiments of systems and methods for providing notification of VM messages using IM transport.

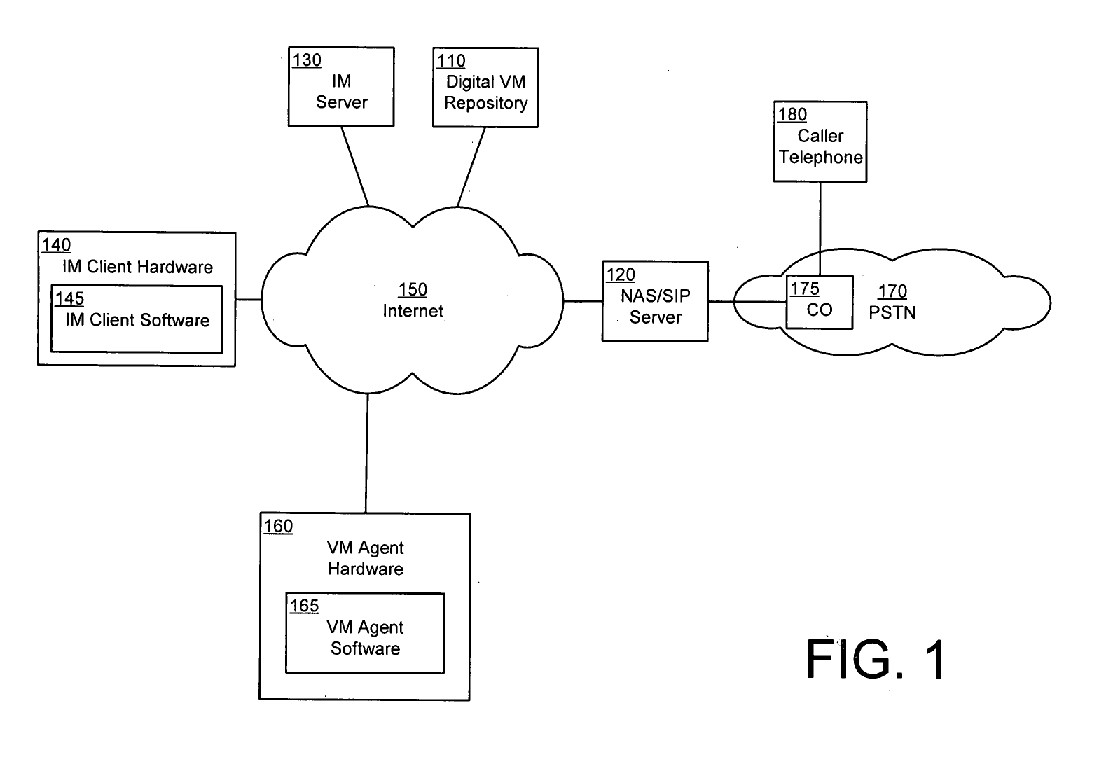

FIG. 1 is a block diagram showing an embodiment of a network having a digital voicemail (VM) repository 110 and an instant messaging (IM) transport. As shown in FIG. 1, the operating environment, for some embodiments, can be seen as a networked environment, such as, for example, various servers and clients communicatively coupled to the Internet 150. Thus, for the embodiment of FIG. 1, an example environment includes a digital voicemail (VM) repository 110 communicatively coupled to the Internet 150, thereby permitting communications between the digital VM repository 110 and other devices or systems that are in communication over the Internet 150. It should be appreciated, for different embodiments, that the Internet 150 can be other types of networks. Since various Internet-based communications protocols are known to those having skill in the art, those protocols are not exhaustively discussed herein.

The embodiment of FIG. 1 further includes an instant messaging (IM) server 130 and IM client hardware 140 coupled to the Internet 150. The communicative coupling of the IM server 130 and the IM client hardware 140 permits communication between the IM server 130 and the IM client hardware 140. The IM client hardware 140 houses IM client software 145. As such, the IM client hardware 140, for some embodiments, can be a personal computer on which the IM client software 145 resides. Since the IM client software 145 performs all of the IM client-side functions, the IM client software 145 is also referred to herein simply as the IM client 145. The IM server 130, as is known in the art, is configured to provide various IM services to the IM client 145. Since various IM protocols are known in the art, further discussion of IM protocols is omitted here. It should also be appreciated that, while not explicitly shown in FIG. 1, the IM server 130 can also include a presence server. Thus, for some embodiments, the IM server 130 can be seen as both a presence and an IM server. In that regard, it should further be appreciated that, for other embodiments, the presence functionality and the IM functionality can be separated into two distinct servers that are in communication with each other and, also, in communication with various other devices. For simplicity of illustration, however, only a single IM server 130 is shown in FIG. 1.

FIG. 1 also includes a public switched telephony network (PSTN) 170 having a central office (CO) 175. The CO 175 is communicatively coupled to a caller telephone 180, thereby providing standard telephone connectivity for a caller at the telephone 180. Since telephony connections and their related protocols are known in the art, further discussions of telephony protocols and PSTN connection protocols are omitted here. The CO 175 is provided Internet access through a network access server (NAS) 120, which may also be configured as a session initiation protocol (SIP) server. For convenience, that server is referred to herein as NAS/SIP server 120. Since PSTN-to-Internet connectivity is known in the art, further discussion of PSTN-to-Internet connectivity is omitted here.

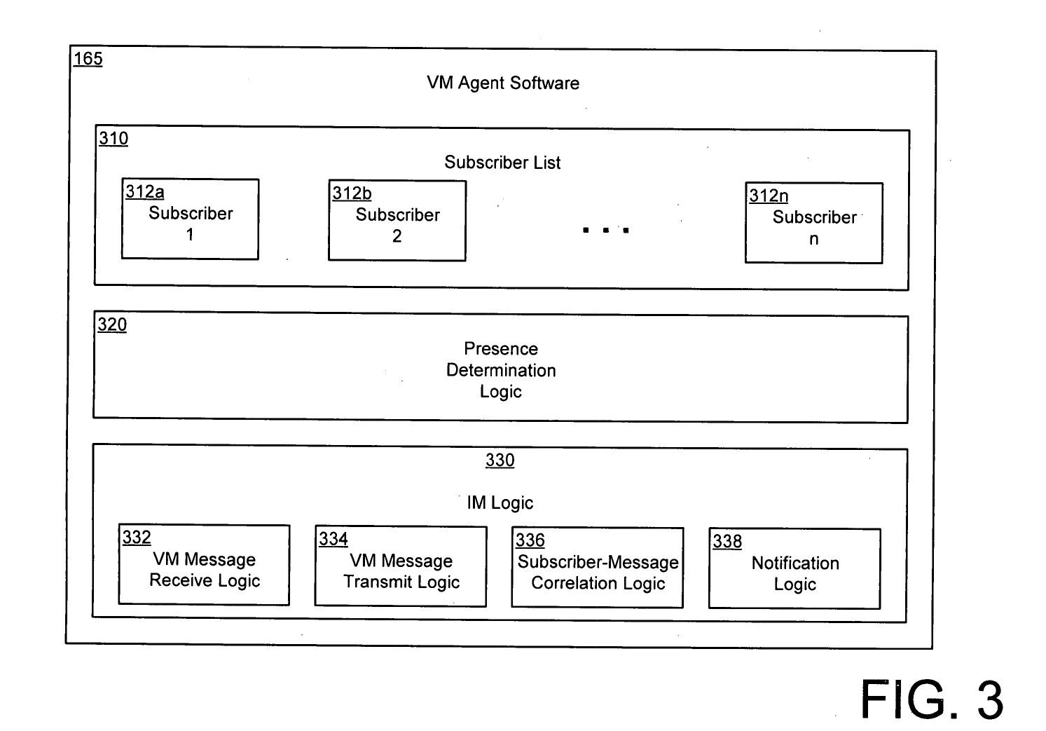

In accordance with one embodiment, among others, FIG. 1 also includes VM agent hardware 160, which houses VM agent software 165. The VM agent hardware 160, for some embodiments, can be a general-purpose computer on which the VM agent software 165 resides. Since the VM agent software 165 performs the various VM functions, regardless of the particular hardware on which the software resides, the VM agent software 165 is also referred to herein simply as the VM agent 165. The VM agent 165, for some embodiments, is a user agent that is specifically configured to communicate with the digital VM repository 110 and the IM client 145. Since the term “user agent” is defined in RFC 2778 and RFC 2779, which are incorporated herein by reference as if set forth in their entireties, further discussions related to user agents are omitted here. While several embodiments of specific configurations for the VM agent 165 are described in greater detail with reference to FIGS. 3 through 8, a brief overview of the operation of the VM agent 165, and various other components, is provided with reference to FIG. 1.

By way of example, the environment of FIG. 1 facilitates a telephone call from a caller to an intended recipient. In that environment, the recipient has a VM mailbox and is also a customer of an IM service. For some embodiments, the VM agent 165 is configured as a subscriber to the digital VM repository 110. For other embodiments, the VM agent 165 is configured as a watcher, or, more specifically, as a poller of the digital VM repository 110. The terms subscriber, watcher, and poller are described in RFC 2778 and RFC 2779. Hence, no further discussion of these terms is presented herein.

When configured as a subscriber to the digital VM repository 110 (hereinafter also referred to as “subscriber embodiments”), the VM agent 165 receives notifications from the digital VM repository 110 when new VM messages are stored at the digital VM repository 110. When configured as a watcher, or, more particularly, as a poller, of the digital VM repository 110 (hereinafter also referred to as “watcher embodiments” or “poller embodiments”), the VM agent 165 polls the VM repository 110 to determine whether new VM messages have been stored at the VM repository 110.

In the environment of FIG. 1, when the caller places a telephone call to the intended recipient, that call is directed from the caller telephone 180 to the CO 175. Typically, the CO 175 directs the call to the intended recipient through the recipient's CO (not shown), and various other known exchanges, using known telephony protocols.

In the event that the intended recipient is unavailable to answer the telephone, the CO 175 directs the telephone call to the recipient's VM mailbox in the digital VM repository 110. Facilitated by the NAS/SIP server 120, the call is directed to the digital VM repository 110 through the Internet 150. The caller then leaves a VM message for the intended recipient at the digital VM repository 110.

For subscriber embodiments, the digital VM repository 110 provides a notification to the VM agent 165. The notification is indicative of a newly-deposited VM message. The VM agent 165 receives the notification and conveys that notification to the IM client 145 using known IM transport mechanisms. If the intended recipient is present online, then the notification over IM is displayed at the IM client of the intended recipient substantially in real time. If the recipient is not present online, then, for some embodiments, the notification by IM is stored at the IM server 130 for delivery to the IM client 145 upon login by the recipient.

For poller embodiments, the VM agent 165 polls the digital VM repository 110. Thus, when a new VM message has been deposited in the digital VM repository 110, the VM agent 165 detects the newly-deposited VM message when the digital VM repository 110 is next polled. In response to the newly-deposited VM message, the VM agent 165 determines the online presence of the recipient. If the recipient is present online, then the VM agent 165 generates an IM message having the notification. The generated IM message is then delivered to the IM client 145 and displayed to the recipient. If the recipient is not present, then the VM agent 165 waits until the recipient logs into the IM account. Thereafter, the VM agent 165 delivers the IM message to the IM client 145 for display to the recipient.

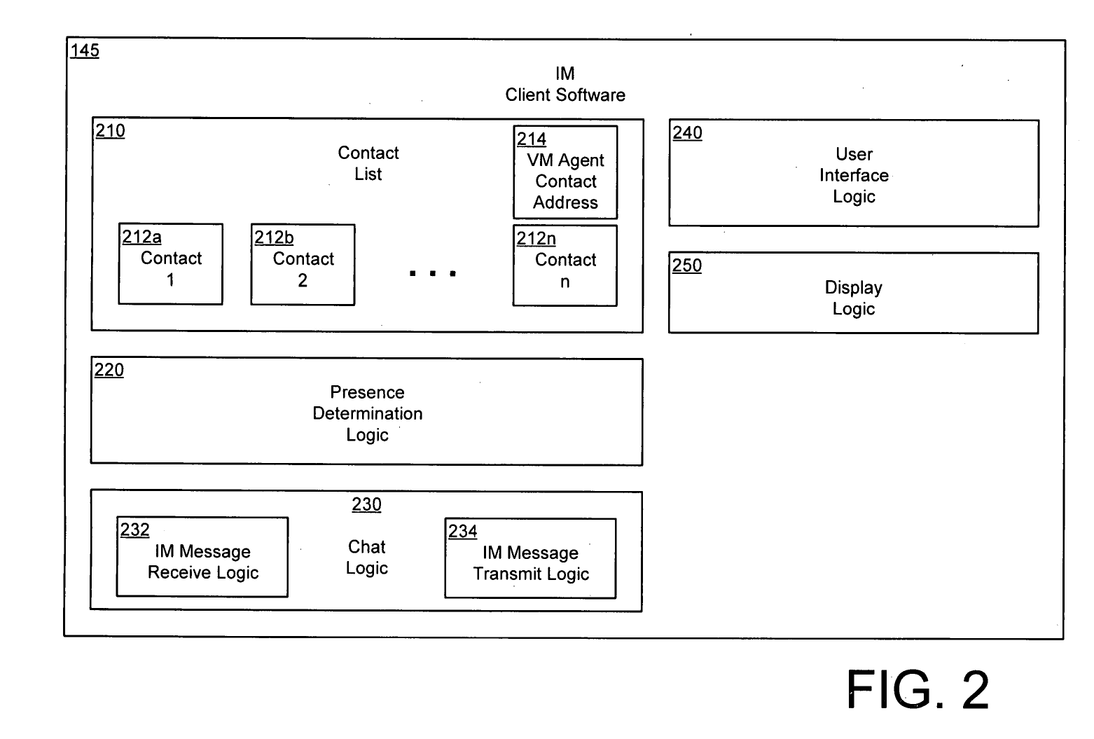

FIG. 2 is a block diagram showing, in greater detail, the IM client software 145 of FIG. 1. As shown in FIG. 1, the IM client software 145 comprises various logic components, such as, for example, a contact list 210, presence determination logic 220, chat logic 230, user interface logic 240, and display logic 250. The contact list 210 includes “contact addresses,” as defined in RFC 2778, for one or more contacts 212a . . . 212n (collectively referred to herein as 212). Additionally, the contact list 210 includes a contact address 214 for the VM agent 165. For some embodiments, the contact address 214 for the VM agent 165 is hard-coded into the IM client 145 and is, therefore, inherent to the IM client 145. For other embodiments, the contact address 214 for the VM agent 165 is a user-selectable address, which, when selected by the user, subscribes to the services of the VM agent 165. For still other embodiments, the contact address 214 of the VM agent need not remain on the IM client 145, once the IM client 145 has subscribed to the VM services of the VM agent 165.

The presence determination logic 220 is configured to perform one or more of the functions of a “presence user agent” as defined in RFC 2778. The chat logic 230 comprises both IM message receive logic 232 and IM message transmit logic 234. The IM message receive logic 232 is configured to perform one or more functions of an “inbox user agent” as defined in RFC 2778. The IM message transmit logic 234 is configured to perform one or more functions of a “sender” as defined in RFC 2778. Since “presence user agent,” “inbox user agent,” and “sender” are known in the art, no further discussions are provided for the various functions of these components or their corresponding structural components.

The user interface logic 240 provides an interface to enable the recipient (or user) to access the various functions of the IM client 145. In one embodiment, among others, the user interface logic 240 generates a graphical user interface (GUI) that enables the user to select and manipulate various features associated with the IM client 145. Since those functions and features are known to those having skill in the art, further discussions of those functions and features are omitted here. The display logic 250 renders incoming and outgoing messages for display, so that the user can view those messages. The display logic 250, for some embodiments, further renders the GUI for display to the user at, for example, a computer monitor screen.

With the exception of the contact address 214 of the VM agent 165, the IM client 145 can be a conventional IM client, as known to those having skill in the art. For other embodiments, if the contact address 214 of the VM agent 165 is no different than the contact address of another IM user, then any conventional IM client can be used for the IM communications aspect of the disclosed systems and methods.

FIG. 3 is a block diagram showing, in greater detail, the VM agent 165 of FIG. 1. The VM agent 165 comprises a subscriber list 310, presence determination logic 320, and IM logic 330. The subscriber list 310 comprises “contact addresses,” as defined in RFC 2778, for one or more subscribers 312a . . . 312n. Thus, in embodiments where the IM client 145 is pre-provisioned with the contact address 214 of the VM agent 165, when a user installs that IM client 145, the contact address 312 of that user is automatically included in the subscriber list 310. For embodiments where the IM client 145 provides a user-selectable option to subscribe to the VM services of the VM agent 165, the contact address of the user is added to the subscriber list 310 when the user enables that option through the IM client 145.

The VM agent 165 further comprises presence determination logic 320. The presence determination logic 320 is configured to perform one or more of the functions of a “presence user agent” as defined in RFC 2778. Thus, the presence determination logic 320 determines whether or not the various subscribers 312 in the subscriber list 310 are present on IM.

In addition to the subscriber list 310 and the presence determination logic 320, for some embodiments, the VM agent 165 further comprises IM logic 330, which includes VM message receive logic 332, VM message transmit logic 334, subscriber-message correlation logic 336, and notification logic 338. It should be appreciated that these various components need not be configured as sub-components of the IM logic 330 but, rather, may be configured as separate logic components within the VM agent 165.

The VM message receive logic 332 is configured to perform one or more functions of an “inbox user agent” as defined in RFC 3778. The VM message transmit logic 334 is configured to perform one or more functions of a “sender” as defined in RFC 3778. In that regard, when a VM message is deposited at the digital VM repository 110, and the digital VM repository 110 issues a notification of the newly-deposited VM message, the VM message receive logic 332 receives the issued notification. The subscriber-message correlation logic 336 is configured to correlate the notification with its corresponding subscriber 312. Since the VM message is deposited to a particular VM mailbox at the digital VM repository 110, the received notification provides an indication of the user that is associated with that particular VM mailbox. The received notification is then included in an IM message by the notification logic 338. That IM message is conveyed to the appropriate recipient through the VM Message transmit logic 334.

In other embodiments, the VM agent 165 polls the digital VM repository 110 for newly-deposited VM messages. When a newly-deposited VM message is detected, the subscriber-message correlation logic 336 correlates the VM message with its corresponding subscriber. Thereafter, the notification logic 338 generates an IM message that includes a notification of the newly-deposited VM message. The VM message transmit logic 334 delivers the generated IM message to the appropriate subscriber.

As shown in the embodiments of FIGS. 1 through 3, the VM agent 165 either actively or passively detects incoming VM messages to the subscriber's VM mailbox. When the subscriber receives a VM message, a notification for that VM message is generated and conveyed to the subscriber's IM client 145 using IM transport.

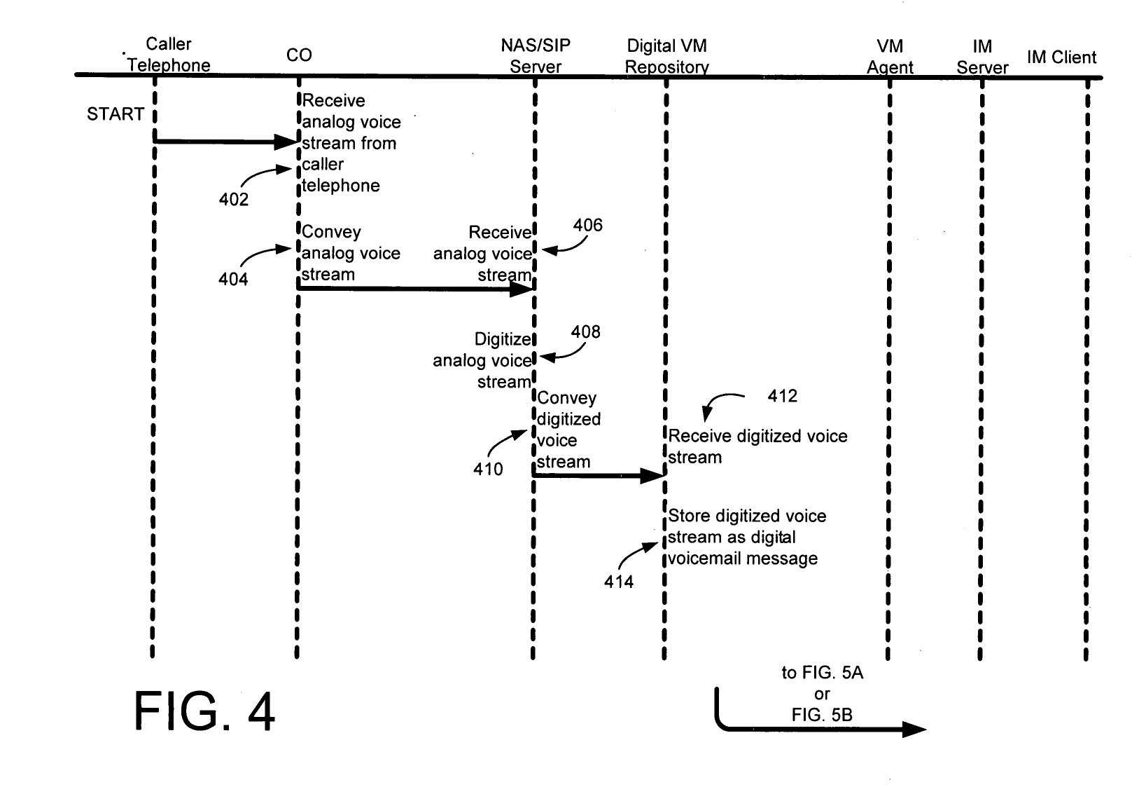

Having described embodiments of systems for providing notifications of VM messages, attention is turned to FIGS. 4 through 8, which describe methods for providing notifications of VM messages.

FIGS. 4, 5A, and 6 are data-flow diagrams showing one embodiment, among others, of a process for storing digital voicemail messages. Specifically, the embodiments of FIGS. 4, 5A, and 6 show processes that are implemented with the network components of FIG. 1. As shown in FIG. 4, one process starts when a caller places a call to an intended recipient from a caller telephone. The central office (CO) receives (402) the analog voice stream from the caller telephone. Upon determining the proper destination, in accordance with known protocols, the CO conveys (404) the analog voice stream to a network access server (NAS), which is also configured as a session initiation protocol (SIP) server (herein referred to as “NAS/SIP server”). The NAS/SIP server receives (406) the analog voice stream and digitizes (408) that analog voice stream. The resulting digitized voice stream is then conveyed (410) from the NAS/SIP server to a digital voicemail (VM) repository. The digital VM repository receives (412) the digitized voice stream, and stores (414) the digitized voice stream as a digital VM message.

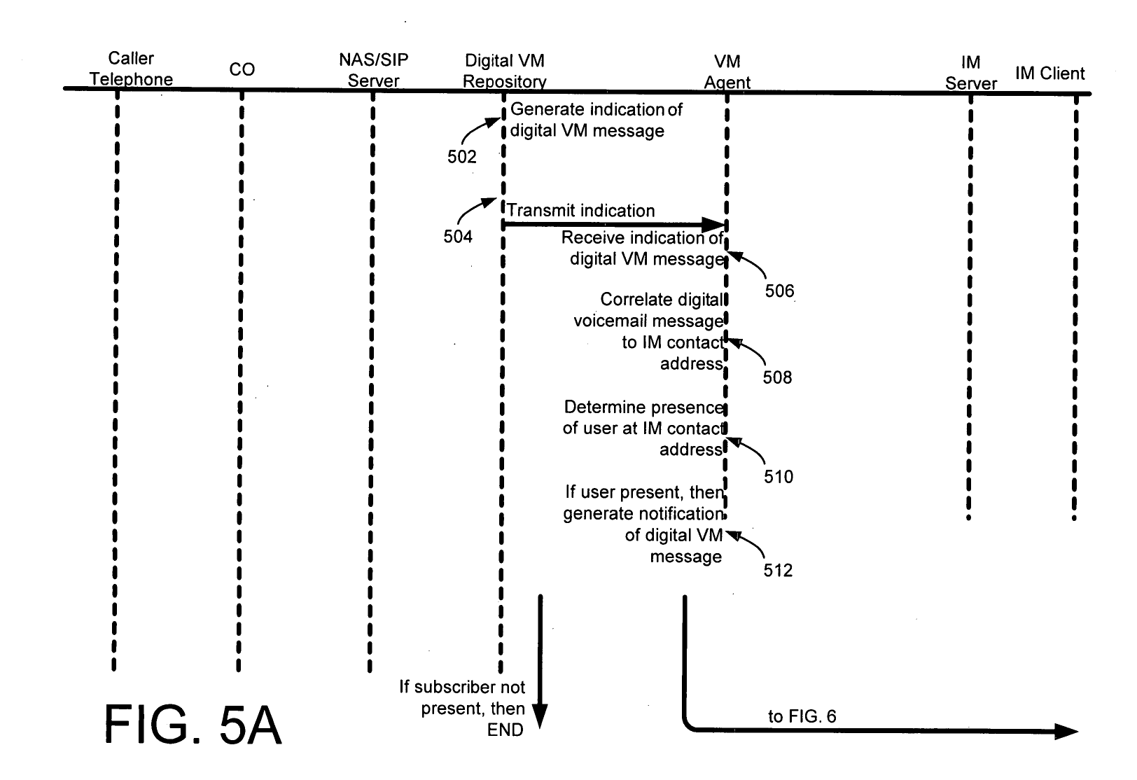

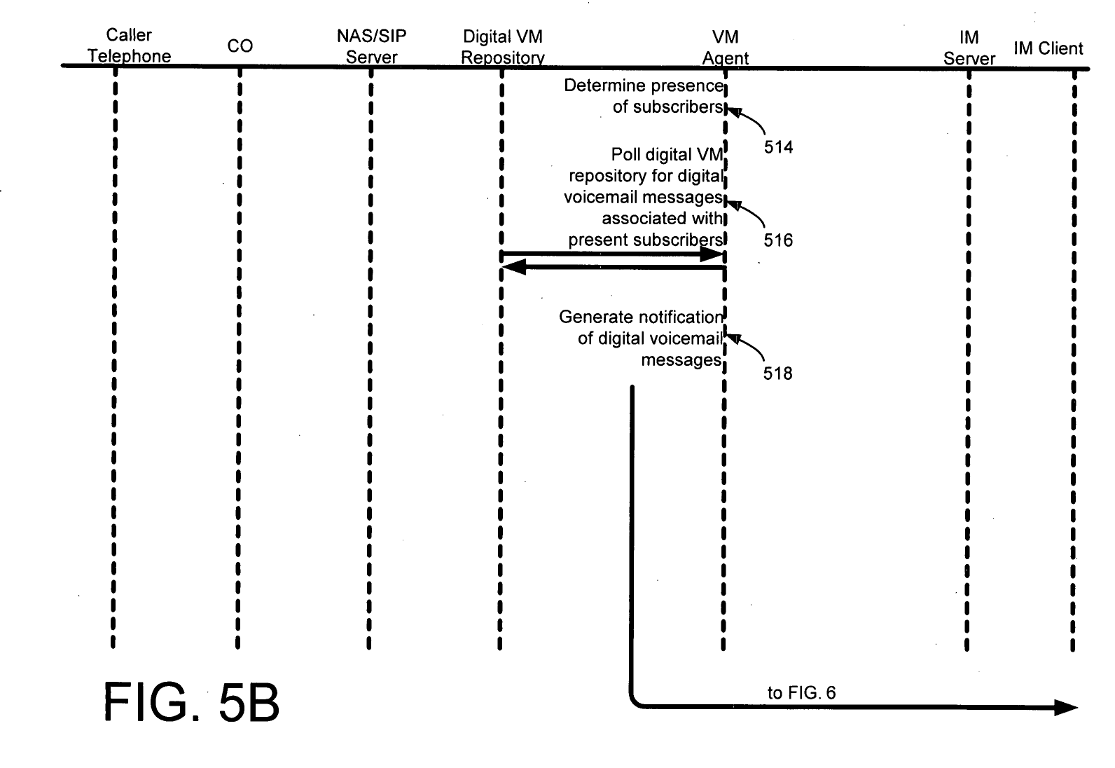

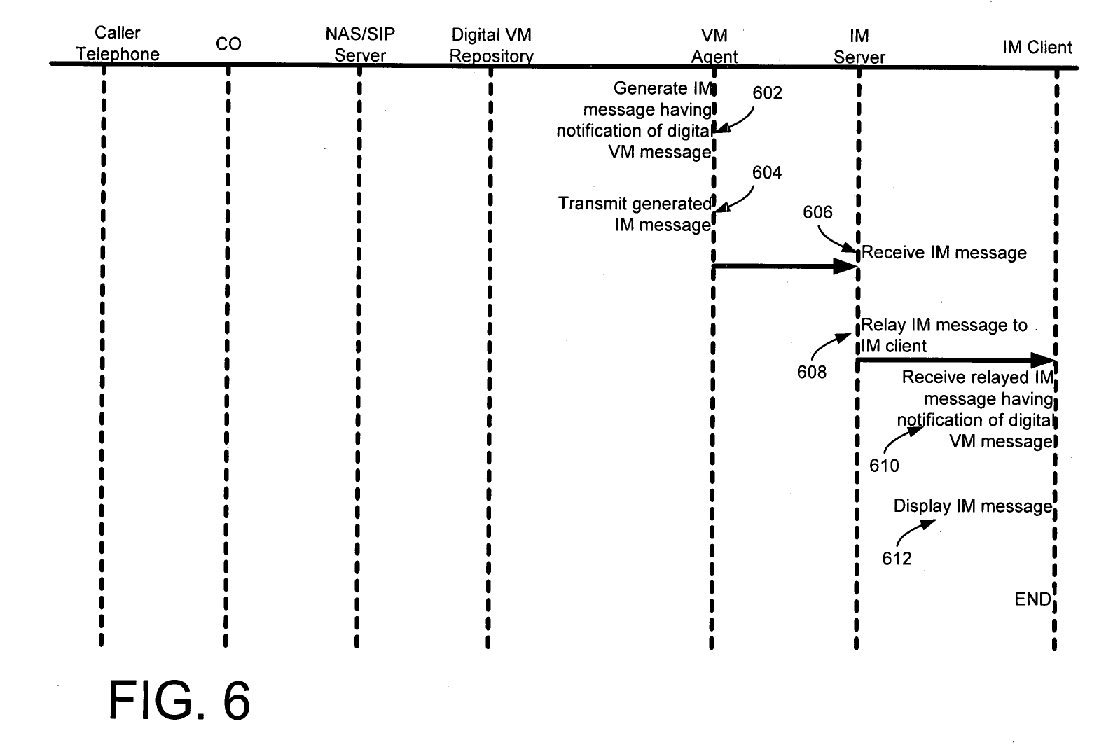

Continuing in FIG. 5A, the digital VM repository generates (502) an indication of the digital VM message, and transmits (504) that indication to a VM agent. The VM agent receives (506) the indication of the digital VM message, and correlates (508) the digital VM message with an IM contact address of a user. Upon correlating (508) the message with a corresponding contact address, the VM agent determines (510) the presence of the user using known mechanisms, such as those outlined in RFC 2778 and RFC 2779. If the user is not present, then the process ends. If, however, the user is present, then the VM agent generates (512) a notification of the digital VM message, and the process continues to FIG. 6.

As shown in FIG. 6, the VM agent generates (602) an IM message, which includes the notification of the digital VM message. The IM message is then transmitted (604) by the VM agent to the appropriate user's IM server. The IM server receives (606) the IM message and relays (608) the IM message to the IM client of the user. The IM client receives (610) the IM message, which includes the notification. The IM message is then displayed (612) to the user, and the process ends.

FIGS. 4, 5B, and 6 are data-flow diagrams showing other embodiments of processes for storing digital voicemail messages within the environment of FIG. 1. As shown in FIG. 4, the process starts when a caller places a call to an intended recipient from a caller telephone. The central office (CO) receives (402) the analog voice stream from the caller telephone. Upon determining the proper destination, in accordance with known protocols, the CO conveys (404) the analog voice stream to a network access server (NAS), which is also configured as a session initiation protocol (SIP) server (“NAS/SIP server”). The NAS/SIP server receives (406) the analog voice stream and digitizes (408) that analog voice stream. The resulting digitized voice stream is then conveyed (410) from the NAS/SIP server to a digital voicemail (VM) repository. The digital VM repository receives (412) the digitized voice stream, and stores (414) the digitized voice stream as a digital VM message.

Continuing in FIG. 5B, the VM agent determines (514) the presence of the various subscribers. For those subscribers that are present, the VM agent polls (516) the subscribers' corresponding VM mailboxes in the VM repository for any digital VM messages associated with those subscribers. Should there be any digital voicemail messages, the VM agent generates (518) a notification for each VM message, and the process continues to FIG. 6.

As shown in FIG. 6, the VM agent generates (602) an IM message, which includes the notification of the digital VM message. The IM message is then transmitted (604) by the VM agent to the appropriate subscriber's IM server. The IM server receives (606) the IM message and relays (608) the IM message to the IM client of the subscriber. The IM client receives (610) the IM message, which includes the notification. The IM message is then displayed (612), and the process ends.

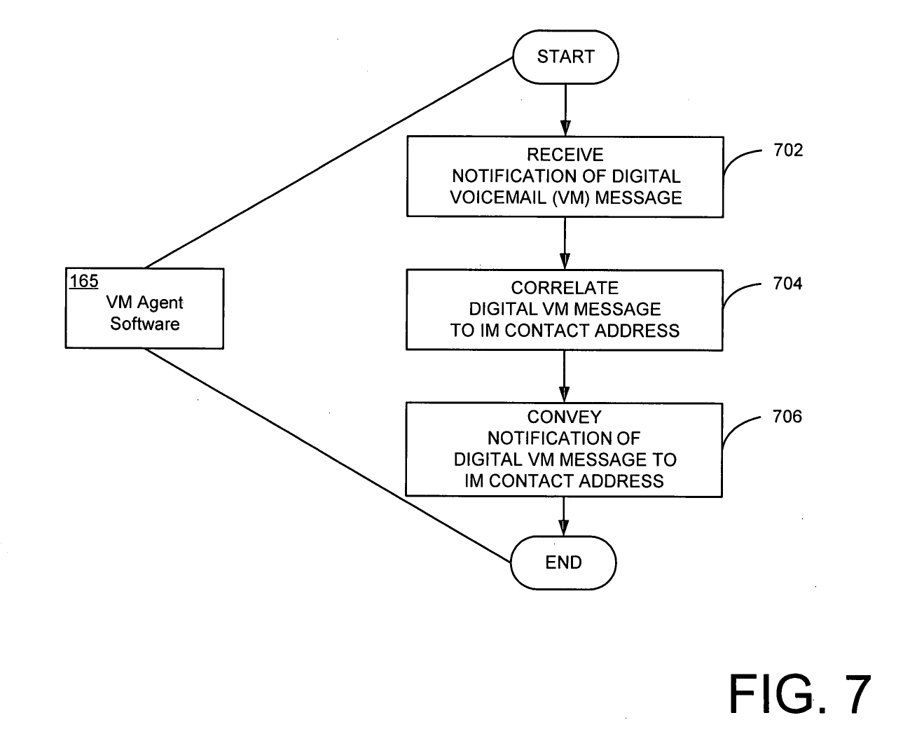

FIG. 7 is a flowchart showing an embodiment of a method for generating a notification of a received digital VM message. In one embodiment, among others, the method of FIG. 7 is executed by the VM agent 165. As such, the process begins by receiving (702) a notification of a digital VM message. The digital VM message is correlated (704) to an IM contact address. Thereafter, the notification of the digital VM message is conveyed (706) to the IM contact address.

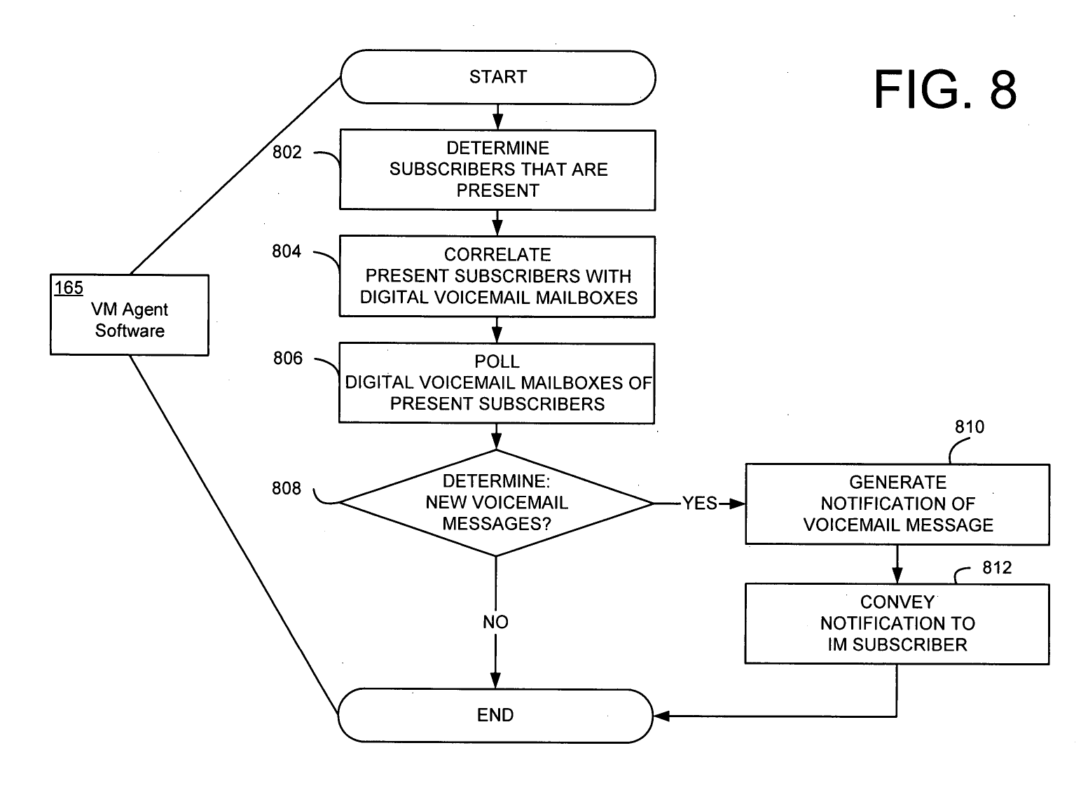

FIG. 8 is a flowchart showing another embodiment of a method for generating a notification of a received digital VM message. The embodiment of FIG. 8 begins when a VM agent 165 determines (802), from a list of subscribers, all of those subscribers that are present. The VM agent 165 correlates (804) the subscribers that are present with their respective digital VM mailboxes. Upon correlating (804) the subscribers to their respective digital VM mailboxes, the VM agent 165 polls (806) the digital VM mailboxes associated with the subscribers that are present. The VM agent 165 further determines (808) whether any new voicemail messages have been deposited into those digital VM mailboxes. If no new VM messages have been deposited, then the process ends. If, however, new VM messages have been deposited, then the VM agent 165 generates (810) a notification of the VM message, and conveys (812) that notification to the appropriate subscriber.

As shown in the embodiments of FIGS. 4 through 6, newly-received VM messages are either actively or passively detected. For newly-received VM messages, notifications for those VM messages are generated and conveyed to their corresponding subscriber's IM client 145 using IM transport. Thus, the embodiments of FIGS. 1 through 8 provide added functionality to IM by providing VM notifications over IM.

The IM client 145, the VM agent 165, the contact list 210, the subscriber list 310, the presence determination logic 220, 320, the chat logic 230, the user interface logic 240, the display logic 250, the IM message receive logic 232, the IM message transmit logic 234, the IM logic 330, the VM message receive logic 332, the VM message transmit logic 334, the subscriber-message correlation logic 336, and the notification logic 338 may be implemented in hardware, software, firmware, or a combination thereof.

In the preferred embodiment(s), the IM client 145, the VM agent 165, the contact list 210, the subscriber list 310, the presence determination logic 220, 320, the chat logic 230, the user interface logic 240, the display logic 250, the IM message receive logic 232, the IM message transmit logic 234, the IM logic 330, the VM message receive logic 332, the VM message transmit logic 334, the subscriber-message correlation logic 336, and the notification logic 338 are implemented in software or firmware that is stored in a memory and that is executed by a suitable instruction execution system.

If implemented in hardware, as in an alternative embodiment, the IM client 145, the VM agent 165, the contact list 210, the subscriber list 310, the presence determination logic 220, 320, the chat logic 230, the user interface logic 240, the display logic 250, the IM message receive logic 232, the IM message transmit logic 234, the IM logic 330, the VM message receive logic 332, the VM message transmit logic 334, the subscriber-message correlation logic 336, and the notification logic 338 can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

The programs represented by the IM client software 145 and the VM agent software 165, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured via, for instance, optical scanning of the paper or other medium, then compiled, interpreted or otherwise processed in a suitable manner if necessary, and then stored in a computer memory.

Although exemplary embodiments have been shown and described, it will be clear to those of ordinary skill in the art that a number of changes, modifications, or alterations to the invention as described may be made.

1. A communications system, comprising:
receive logic configured to receive an indication of a digital voicemail (VM) message, the digital voicemail message being correlated to an instant messaging (IM) contact address;
notification logic configured to generate a notification, the notification being correlated to the digital VM message; and
transmit logic configured to transmit the notification to the IM contact address over an IM transport.

2. The system of claim 1, further comprising FTP logic configured to transfer the notification over an IM file transfer protocol (FTP) transport.

3. The system of claim 1, further comprising means for transferring the notification over an IM file transfer protocol (FTP) transport.

4. The system of claim 1, wherein the notification logic is further configured to determine a location of the digital VM message, the notification logic further being configured to generate a link to the location of the digital VM message, the notification logic further being configured to include the link in the notification.

5. The system of claim 1, wherein the link is a universal resource locator (URL) associated with the digital VM message.

6. The system of claim 1, further comprising:
means for determining a location of the digital VM message;
means for generating a link to the location of the digital VM message; and
means for including the link in the notification.

7. The system of claim 1, further comprising:
means for determining a universal resource locator (URL) of the digital VM message; and
means for including the URL in the notification.

8. A communications method, comprising the steps of:
receiving an indication of a digital voicemail (VM) message, the digital voicemail message being correlated to an instant messaging (IM) contact address;
generating a notification correlated to the digital VM message; and
transmitting the notification to the IM contact address over an IM transport.

9. The method of claim 8, further comprising the step of correlating the digital VM message to the IM contact address.

10. The method of claim 8, further comprising the step of determining an online presence of a user at the IM contact address prior to transmitting the notification.

11. The method of claim 10, wherein the step of transmitting the notification is responsive to determining that the user is present.

12. The method of claim 8, further comprising the step of transferring the notification over an IM file transfer protocol (FTP) transport.

13. The method of claim 8, further comprising the steps of:
determining a location of the digital VM message;
generating a link to the location of the digital VM message; and
including the link in the notification.

14. The method of claim 13, wherein the step of generating the link comprises the step of generating a universal resource locator (URL) associated with the digital VM message.

15. A computer-readable medium, comprising:
computer-readable code adapted to instruct a programmable device to receive an indication of a digital voicemail (VM) message;
computer-readable code adapted to instruct a programmable device to correlate the digital voicemail message to an instant messaging (IM) contact address;
computer-readable code adapted to instruct a programmable device to generate a notification of the digital VM message; and
computer-readable code adapted to instruct a programmable device to transmit the notification to the IM contact address over an IM transport.

16. The computer-readable medium of claim 15, further comprising computer-readable code adapted to instruct a programmable device to determine an online presence of a user at the IM contact address prior to transmitting the notification.

17. The computer-readable medium of claim 15, further comprising computer-readable code adapted to instruct a programmable device to transfer the notification over an IM file transfer protocol (FTP) transport.

18. The computer-readable medium of claim 15, further comprising:
computer-readable code adapted to instruct a programmable device to determine a universal resource locator (URL) of the digital VM message; and
computer-readable code adapted to instruct a programmable device to include the URL in the notification.
